(19) United States
(12) Patent Application Publication
(10) Pub. No.: US 2012/0058700 A1
(43) Pub. Date: Mar. 8, 2012

(54) TRI-FUNCTION, INTEGRATED, PLURAL-LAYER BARRIER COATING STRUCTURE FOR A COMBUSTIBLE-LIQUID CONTAINER

(75) Inventors: Thomas S. Ohnstad, Salem, OR (US); Russell A. Monk, Salem, OR (US)

(73) Assignee: High Impact Technology, L.L.C., Tigard, OR (US)

(21) Appl. No.: 13/218,383

(22) Filed: Aug. 25, 2011

Related U.S. Application Data
(60) Provisional application No. 61/380,222, filed on Sep. 4, 2010.

(51) Int. Cl. D04B 1/00; B32B 9/04

(52) U.S. Cl. 442/304; 428/411.1

(57) ABSTRACT

A tri-function, self-sealing, anti-leakage and fire-extreme-heat-protective coating for, and applicable to the outside of, a liquid-fuel container, including (a) an inner layer portion with a structural propensity for sealing inwardly directed container puncture wounds, (b) an intermediate layer portion with a structural propensity for sealing outwardly directed container puncture wounds, and (c) an outer layer portion with combined structural propensities (1) for sealing all-direction container puncture wounds and (2) for minimizing heat rise within a protected container due to a fire or an extreme heat condition adjacent the outside of the container.

### CROSS REFERENCE TO RELATED APPLICATION

This application claims filing-date priority to U.S. Provisional Patent Application, Ser. No. 61/380,222, filed Sep. 4, 2010, for “Tri-Function, Integrated, Barrier Layer Structure For a Combustible-Liquid Container”, the entire disclosure content in which is hereby incorporated herein by reference.

### BACKGROUND AND SUMMARY OF THE INVENTION

The present invention relates to a special, integrated, tri-function, plural-layer barrier coating structure for protecting, in several, different ways, a combustible liquid container, such as vehicle fuel container. This structure is employed as a plural-layer-portion coating (with plural layers present in each coating portion) applied to the outside surface of such a container. It protects, in special bidirectional ways, against puncture-wound-introduced liquid leaks—including leaks initiated by both inwardly directed and outwardly directed puncture wounds—and, in addition, has a special characteristic in its outermost layer portion for protecting against fire, as well as against any otherwise threatening condition of extreme heat, such as a temperature of around 500° F., which might develop adjacent the outside of a protected container.

In accordance with the invention, there are, within the proposed, integrated barrier coating structure, three different layer portions, or regions, which are integrated, effectively, as parts of the whole protective coating structure.

In this arrangement, the innermost layer portion is constructed, preferably, in accordance with aspects of the teachings of U.S. Pat. No. 7,169,452—a patent covering an invention entitled “Projectile Barrier and Method”. This innermost portion functions to furnish a combined, liquid-contact-reacting, high-elastomeric and liquid-imbiber-component swelling and congealing action which, while generally effective to deal both with inwardly directed and outwardly directed puncture wounds, has a propensity for dealing with inwardly directed container puncture wounds regarding which a punctured container wall “flowers” inwardly, rather than outwardly (relative to a punctured container wall) at the site of such a wound.

An intermediate portion of the proposed, integrated barrier coating structure features, along with a liquid-contact-reacting, high-elastomeric material like that just mentioned above regarding the coating structure's innermost portion, the presence of a three-dimensional-knit spatial fibre mat, implemented generally in accordance with the teachings of currently copending U.S. Regular patent application Ser. No. 13/083,559, filed Apr. 9, 2011, for “Liquid-Container Coating Structure With Flower-Indifferent, Puncture-Wound, Self-Sealing Capability”. As will be seen, this intermediate coating portion, while characterized structurally for dealing both with inwardly and with outwardly directed puncture wounds, has a definitive propensity for dealing especially well with outwardly directed container puncture wounds wherein a punctured container wall “flowers” outwardly. The spatial fibre mat, positioned as proposed by the present invention, prevents an outwardly splayed container-wound flower from defeating, or in other ways interfering with, an intended elastomeric sealing action. It does this by “spatially receiving” outwardly long and aggressive, jagged flower petals in such a wound, and by thereby furnishing container-wound flower-petal non-contact spacing from an outwardly positioned elastomeric sealing mass, thus preventing the petals in such a flower wound from holding open an associated, outwardly adjacent, elastomeric-material puncture-wound penetration passage.

An outer, or outermost, layer portion in the proposed, integrated barrier coating structure is constructed in accordance preferably with aspects of the teachings of U.S. Pat. No. 7,678,453—a patent covering an invention entitled “Multi-Function Surface-Coating Fire and Fuel-Leakage Inhibition”. This portion features a high-elastomeric-bodied mass preferably made of the same high-elastomeric mentioned above, which mass includes both embedded liquid-imbiber components and embedded heat-reactive, swellable, intumescence elements. This outermost portion, while also structured to furnish bidirectional, liquid-reaction, elastomeric puncture-wound sealing, has a propensity, because of the intumescence-element presence, to defend against the possibility of a nearby external fire, or of a nearby extreme heat condition, such as a temperature of around 500° F., causing a container fire and a possible explosion.

The entire disclosure contents of above-identified (U.S. Pat. Nos. 7,169,452 and 7,678,453) and U.S. patent application (Ser. No. 13/083,559) are hereby incorporated herein by reference.

Regarding the coating structure of the invention, surprisingly, the mentioned, three, included layer regions, when internally constructed in accordance with, and when integrated in the order and arrangement proposed by, the present invention, offer an extraordinarily effective and functionally substantially seamless approach to dealing protectively with a very wide range of potentially dangerous, and unpredictably “arriving” and realized, fuel-container-wound threats and resulting puncture-wound consequences, and with serious, nearby fire, and/or extreme heat, conditions.

The expressed concept of “plural” layer portions should be understood to refer to an integrated structure in the form of a coating wherein inner, intermediate and outer portions are cooperatively united, but not necessarily contactively interfaced via discontinuities. Rather these portions may, depending upon user-selectable fabrication, “flow” essentially seamlessly from one to another.

One way of thinking about the structure of the present invention is that it is a self sealing, anti-leak and fire-protective coating for, and applicable to the outside of, a liquid-fuel container, this coating including (a) an inner portion with a propensity for sealing inwardly directed container puncture wounds, (b) an intermediate portion with a propensity for sealing outwardly directed container puncture wounds, and (c) an outer portion with a propensity for minimizing heat rise within a protected container due to a fire and/or an extreme heat condition (a temperature of around 500° F.) adjacent the outside of the container. As will become apparent, these specific, layer-portion propensities do not exclusively define the entireties of the respective layer-portion, protection-offering behaviors.

Another way of characterizing the invention is that it takes the form of tri-function, plural-intercooperative-layer barrier coating structure applicable to the outside surface of the wall in a combustible-liquid container for protecting against consequences resulting from container-puncture-wound-induced liquid leakage, this coating structure, in operative condition relative to such a surface, including (1) an inner, plural-layer portion disposed immediately operatively adjacent the mentioned container-wall surface, structured generally for liquid-reactive, self-sealing behavior regarding both entering and exiting container-wall puncture wounds, while possessing a specific structural propensity for handling entering container-wall puncture wounds, (2) an intermediate, puncture-flower-indifferent, plural-layer portion disposed immediately, operatively, and outwardly adjacent the inner layer portion relative to the container-wall surface, also structured generally for liquid-reactive, self-sealing behavior regarding both entering and exiting container-wall puncture wounds, while possessing a specific structural propensity for handling exiting container-wall puncture wounds, and (3) an outer, plural-layer portion disposed immediately, operatively, and outwardly adjacent the intermediate layer portion relative to the inner layer portion, also structured generally for liquid-reactive, self-sealing behavior regarding both entering and exiting container-wall puncture wounds, while possessing a structural propensity for furnishing an intumescence-response to any proximate fire or extreme heat condition disposed adjacent its outside surface.

The proposed tri-layer barrier structure thus furnishes a unique, three-way combination of protection against catastrophic events which might flow from various kinds of liquid-container puncture wounds, and any resultant, or otherwise created, outside closely adjacent fire or condition of extreme heat. These and other features and advantages which are attained and offered by the invention will become more fully apparent as the detailed description of it which shortly follows is read in conjunction with the single drawing FIGURE.

### DESCRIPTION OF THE DRAWING FIGURE

The single drawing FIGURE pictures, fragmentarily, and in cross section, a preferred and best-mode embodiment of the tri-function, plural-intercooperative-layer barrier coating structure of the present invention shown in an operative condition applied to the outside surface of the wall in a liquid fuel container. Layers, and components pictured in certain ones of these layers, are not drawn to scale.

### DETAILED DESCRIPTION OF THE INVENTION

Turning now to the drawing FIGURE, indicated generally at 10, constructed in accordance with a preferred and best-mode embodiment of the present invention, is a tri-function, plural-inter-cooperative-layer barrier coating structure, or coating, also referred to herein as a tri-function, self-sealing, anti-puncture-wound-leak and fire-protective, coating. This coating, which is intended for application to the outside surface of the wall in a combustible-liquid container, such as a petroleum-based fuel tank, is specifically illustrated in the drawing FIGURE as being so applied to the outside surface 12a in the wall 12b of such a container 12.

In general terms, coating structure 10 includes an inner, plural-layer portion, also referred to as an inner layer portion 14, within which are included a central layer 14a, bracketed on its opposite sides, or faces, by a pair of adjacent, inner and outer layers 14b, 14c, respectively. Each of layers 14a, 14b, 14c includes a main, or principal, body 16 of a suitable high-elastomeric, combustible-liquid-reactive material which will the described more fully shortly, and central layer 14a further includes, embedded in the high-elastomeric material, a population of distributed, combustible-liquid imbiber beads, such as those shown at 18.

Also generally forming part of coating structure 10 is an intermediate, puncture-flower-indifferent, plural-layer portion 20 which includes an inner, three-dimensional-knit, spatial fibre mat-material, layer 20a, and an outer layer 20b which is formed entirely of the same liquid-reactive, high-elastic material mentioned above with respect to inner layers 14a, 14b, 14c. The spatial fibre mat material included in layer 20a, more fully described hereinbelow, is shown at 22. The high-elastomeric material in layer 20b is shown at 24.

The spatial fibre-mat material is conveniently, and conventionally, covered on its opposite, broad faces by thin, fabric, containment layers made of nylon. These nylon layers, which are not specifically labeled in the drawing, coincide with the two, spaced, parallel lines that mark the opposite sides of layer 20a.

Additionally present in coating structure 10 is an outer, plural-layer portion 26 which includes inner and outer layers 26a, 26b, respectively, collectively formed with what is referred to herein as a main body 28 of the same liquid-reactive, high-elastomeric material mentioned above, and within which layers, in inner layer 26a, there is included an embedded population of liquid-reactive imbiber beads 30 that are the same as imbiber beads 18 mentioned above, and in outer layer 26b there is included an embedded population of intumescence elements 32—described in more detail below.

As will be more fully explained shortly, (a) inner layer portion 14 possesses a specific, but not exclusive, structural propensity for handling entering container-wall puncture wounds, (b) intermediate layer portion 20, a specific, but not exclusive, structural propensity for handling exiting container-wall puncture wounds, and (c) outer layer portion 26, combined structural propensities (1) for sealing all-direction container-wall puncture wounds, and (2) for minimizing heat rise within a protected container due to a fire disposed adjacent the outside of the container.

We have discovered that, in terms of assembling these three, different plural-layer portions which make up coating structure 10 in its preferred embodiment, as illustrated, the organizational order of these layer portions is important.

More specifically, it is, of course, important that outer layer portion 26, which bears a principal responsibility for dealing with protection against a dangerous fire or extreme (about 500° F.) heat condition on the outside of a protected container be located as the outermost layer portion.

Beyond that, it turns out to be functionally important that, for dealing with most container puncture-threat conditions, the inner and intermediate layer portions should preferably be organized in the order illustrated. In this regard, while it is very important that intermediate layer portion 20, with its included spatial fibre mat material, be well positioned to deal accommodatingly with exit-wound tank-wall flowers, so that the petals in such a flower will not inhibit elastomeric self-sealing against leakage, as discussed above, we have discovered to our surprise that this layer portion, in most puncture-wound-occurrence situations, instead of being disposed directly adjacent the outside surface of the wall in a liquid container, should preferably be spaced from that surface, and positioned immediately outwardly of inner layer portion 14, wherein each of the included, three layers offers individually aggressive, rapid and “close-in” leakage-sealing puncture-wound closure response immediately adjacent the container-wall surface, and next “inboard” of the spatial fibre mat-material layer portion.

With respect to this specific, layer-portion arrangement, wherein the three-layer layer portion 14 sits directly against the outside of a container wall, and the spatial fibre mat-material layer portion forms the next, and central, part of the whole coating structure, we have observed that the proposed coating structure, under most circumstances, offers the most robust and quick-acting anti-leakage sealing of a puncture wound perhaps principally because.

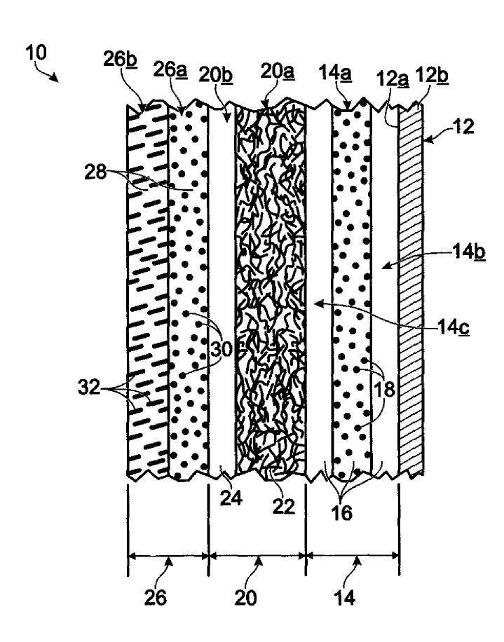

Saying a bit more now specifically about the three plural-layer portions included in coating structure 10, inner layer portion 14 is preferably constructed in accordance with what is pictured in FIGS. 3 and 4 in the above-identified '452 Patent.

The liquid-reactive, high-elastomeric material employed herein—which is also a high-tensile-strength, high-tear-resistance material—is preferably the two-component polyurethane elastomer product sold under the trademark TUFF STUFF®FR, made by Rhino Linings USA, Inc.—a company based in San Diego, Calif. This same, high-elastomeric material is used throughout coating structure 10, and specifically in all of the other included layers which include high-elastomeric material. This elastomeric material functions very effectively in the coating structure to furnish, on the occasion of a puncture wound, both a powerful, self-sealing, elastomeric wound closure behavior, and a liquid-reactive, material swelling and congealing sealing action.

All of the layers which exist within inner layer portion 14, and this is also true with respect to all of the other layers included in coating structure 10 except for spatial fibre mat layer 20a, are preferably fabricated utilizing an appropriate, spray-application technique. The present invention does not relate in any way to such a technique—one which may be entirely conventional in nature Accordingly, details of a spray-application process are not described herein.

Within inner layer portion 14, layer 14b has a preferred thickness of about ¼-inches, layer 14c a preferred thickness of about ¼- to about ⅜-inches, and layer 14a a preferred thickness preferably lying within the range of about ⅛- to about 3/16-inches.

Liquid-imbiber beads 18 in layer 14a herein are made of the imbiber-bead product identified as IMB230300, made by Imbibitive Technologies America, Inc. in Midland, Mich. These beads preferably are blended, in any appropriate manner during a layer-creation spraying operation, into entraining high-elastomeric material 16 so as to constitute about 20% by weight of the thus blended/combined material which makes up layer 14a.

In intermediate layer portion 20, layer 20a herein has a preferred thickness of about ¼-inches, and layer 20b also a preferred thickness of about ¼-inches. A preferred, three-dimensional, spatial knit fibre mat material usable in layer 20a is the product (or part) designated #SHR705/60″ Black #9321, made by Gehring Textile, Inc., in Garden City, N.Y.

Layer portion 26 herein preferably is made in accordance with what is illustrated in FIG. 7 in the above-identified '453 patent. Accordingly, each of layers 26a, 26b preferably has a thickness of about ⅛-inches. Within layer 26a, imbiber beads 30 are, as was mentioned earlier, the same as those specifically discussed above in relation to layer 14a, with these beads similarly, by percentage of weight, occupying the totality of layer 26a.

Intumescence elements 32 in layer 26b preferably take the form herein of sodium silicate crystals which have a mesh size of about 100-mesh. These crystals, when exposed to nearby, intense heat, such as heat with a temperature of about 500° F., respond with a rapid, popping, volumetric expansion which causes, effectively, a resulting container-protecting thickening of layer 26b. It is this intumescence-reaction behavior which is effective to protect a combustible-liquid container, such as container 12, against intense fire and heat present adjacent the outer side of outer layer portion 26. Intumescence elements 32 preferably occupy about 30% to about 50% by volume of the total volume of layer 26b.

With the various layer portions that make up coating structure 10 having the structural puncture-wound response propensities, and other properties, described above, and with these layer portions organized in the important fashion described above herein, coating 10 offers a robust level of protection against a very wide variety of aggressive container wounds produced, for example, by high-speed projectiles such as bullets and shrapnel coming from an explosive device. Moreover, in addition to furnishing rapid and effective self-sealing against puncture-initiated combustible-fluid leakage, layer 26b, the “intumescence-element” layer within outer layer portion 26, responds with the kind of behavior described above, and further described in the '453 patent to protect a guarded container, such as container 12, against a possible contained fuel ignition and explosion as a consequence of the presence of a fire or other source of high temperature disposed immediately adjacent the outer surface of the coating.

While, accordingly, a preferred and best-mode embodiment of the invention has been illustrated and described herein, we appreciate that variations and modifications may be made without departing from the spirit of the invention, and we anticipate that all such variations and modifications will be considered to be within the scope of the appended claims.

We claim:

1. Tri-function, plural-intercooperative-layer barrier coating structure applicable to the outside surface of the wall in a combustible-liquid container for protecting against consequences resulting from container-puncture-wound-induced liquid leakage, and container exposure to fire or extreme, nearby heat, said coating structure, in operative condition relative to such a surface, comprising
an inner, plural-layer portion disposed immediately operatively adjacent the mentioned container-wall surface, structured generally for liquid-reactive, self-sealing behavior regarding both entering and exiting container-wall puncture wounds, while possessing a specific structural propensity for handling entering container-wall puncture wounds,
an intermediate, puncture-flower-indifferent, plural-layer portion disposed immediately, operatively, and outwardly adjacent said inner layer portion relative to the container-wall surface, also structured generally for liquid-reactive, self-sealing behavior regarding both entering and exiting container-wall puncture wounds, while possessing a specific structural propensity for handling exiting container-wall puncture wounds, and
an outer, plural-layer portion disposed immediately, operatively, and outwardly adjacent said intermediate layer portion relative to said inner layer portion, also structured generally for liquid-reactive, self-sealing behavior regarding both entering and exiting container-wall puncture wounds, while possessing a structural propensity also for furnishing an intumescence-response to any proximate fire or extreme heat condition disposed adjacent the container wall's outside surface.

2. The coating structure of claim 1, wherein (a) said inner layer portion includes a central layer formed of a liquid-reactive, high-elastomeric material containing an embedded population of liquid-reactive, liquid-imbiber beads, bracketed by a pair of adjacent layers each formed solely by the same, just-mentioned, liquid-reactive, high-elastomeric material, (b) said intermediate layer portion includes a three-dimensional-knit spatial mat-material layer, and immediately outwardly thereof a layer of the same, just-mentioned liquid-reactive, high-elastomeric material, and (c), said outer layer portion includes a main body including two layers principally formed of the same, just-mentioned liquid-reactive, high-elastomeric material, one of which two layers possesses an embedded population of liquid-reactive, liquid-imbiber beads, and the other of which possesses an embedded population of intumescence elements.

3. A tri-function, self-sealing, anti-puncture-wound-leak and fire-protective coating for, and applicable to the outside of, a liquid-fuel container, comprising
(a) an inner layer portion possessing a structural propensity for sealing inwardly directed container puncture wounds, applicable directly to the outside of a liquid-fuel container,
(b) an intermediate layer portion possessing a structural propensity for sealing outwardly directed container puncture wounds, disposed immediately outwardly, contactively and operatively adjacent said inner layer portion, and
(c) an outer layer portion possessing combined structural propensities (1) for sealing all-direction container puncture wounds and (2) for minimizing heat rise within a protected container due to a fire or an extreme heat condition adjacent the outside of the container, disposed immediately outwardly, contactively and operatively adjacent said inner layer portion.

4. The coating of claim 3, wherein each of said layer portions includes at least one layer having a body of liquid-reactive, high-elastomeric material which is structured, on the occurrence of a liquid-leakage-producing puncture wound in that material to implement both an elastomeric, and a leakage-liquid, contact-initiated reactive, anti-leakage, self-sealing action.
